(19) United States
(12) Patent Application Publication
(10) Pub. No.: US 2022/0331712 A1
(43) Pub. Date: Oct. 20, 2022

(54) COMPOSITION FOR SEPARATION OF AN OIL WATER MIXTURE

(71) Applicant: WOW KEMICAL S.R.L., vigonza (PD) (IT)

(72) Inventors: Adriano Marin, Baone (PD) (IT); Emanuele Amadio, Casale sul Sile (TV) (IT)

(21) Appl. No.: 17/763,776

(22) PCT Filed: Oct. 9, 2020
(86) PCT No.: PCT/IB2020/059494

§ 371 Date: Mar. 25, 2022

(30) Foreign Application Priority Data
Oct. 11, 2019 (IT) 102019000018548

(51) Int. Cl. B01D 17/04

(52) U.S. Cl. CPC B01D 17/047; B01D 2221/04

(57) ABSTRACT

The present invention relates to a method for the separation of an oily mixture from an aqueous mixture and a kit for use in said method.

The present invention relates to a method for separating an oily mixture from a mixture or emulsion of an aqueous medium and said oily mixture and a kit of compositions for use in said method.

During extraction operations of oil from the soil, significant quantities of oil and layer water mixtures are normally extracted.

Layer water is the water entrapped in subsoil formations that is brought to the surface in a mixture or emulsion with oil. Layer water contributes to the greater volume of waste stream associated with oil and gas production. The quantity of layer water extracted with the oil increases towards the end of the operational life of the well. In low-performance wells that are at the end of their useful life, which typically has a duration of 50 years, the quantity of layer water extracted is such as to make exploitation of the well economically unjustifiable, even if potentially usable crude oil is still present

Globally, 77 billion barrels of water are produced annually. Conventional methods of managing the waste stream are re-injection into the well, direct discharge or reuse in the case of a thermal loop.

Of these, at present, the most efficient way of handling is its re-injection into disposal wells. The disposal costs, which include the cost of transportation, the cost of capital, and the cost of maintaining the infrastructure, can be as high as $4.00 per barrel.

Many oil-producing regions (West Texas, the Middle East and Central Asian republics) on the other hand, have a shortage of drinking water. An affordable water treatment process could convert layer water into a usable asset, with benefits for the community.

The damaging effects of layer water and the depletion of usable water resources act as a driving force for the treatment of extraction products.

Layer water contains soluble and insoluble organic compounds, dissolved solids, production chemicals (corrosion inhibitors, surfactants, etc.) and solid particles due to the leaching of rocks and corrosion of pipelines.

The methods currently available for treating oil-extracted layer water involve physical, chemical, biological and membrane-treatment processes.

Chemical treatments include precipitation by coagulation and flocculation, which is unable to separate the dissolved components and leads to the formation of a slime with a high concentration of heavy metals, oxidation, through a strong oxidizing agent which is activated by radiation in the presence of a catalyst or through the Fenton process, which involves oxidation in the presence of ferrous sulfate or by means of ozone, the use of demulsifiers for breaking the emulsion that is formed during the extraction process and electrochemical processes. All the forms of chemical treatment currently available have high costs, lead to the almost total degradation of the oil and involve the production of high volumes of highly contaminated by-products which must be disposed of, with additional costs, to limit environmental damage.

Strict water-quality parameters can be efficiently achieved through microfiltration (MF), ultrafiltration (UF) and nanofiltration (NF) membrane processes.

The use of membranes involves the disadvantage of fouling. Irreversible and reversible encrustations, in fact, occur during the treatment of layer water which can be reduced by pre-treatment of the membranes.

Commercial membrane treatment methods based on reverse osmosis and ion exchange are, for these reasons, expensive and laborious.

Alternative physical methods comprise physical adsorption (e.g. with activated carbon, zeolites or resins), sand filters (especially for removing heavy metals), cyclone separators, which have a low efficiency and are unable to remove dissolved components, and evaporation which has high operating costs due to the high energy requirement.

Another important problem relating to oil extraction, transportation, refining and processing operations is represented by the generally accidental spills of oil, or its components and derivatives into the environment.

In recent decades, due to accidents in industrial plants and off-shore extraction platforms, losses from tankers, and also as a result of natural or war events, there have been spills of huge quantities of oil and derivatives that have led to the contamination of vast areas, especially, but without limitation, in marine and coastal areas. Also in the case of spills, the oil must be efficiently separated from aqueous matrices, limiting permanent contamination of the aqueous masses as much as possible.

The means currently available for separating mixtures and emulsions of water and oil are unsatisfactory. The need is therefore felt for finding methods for the separation of systems comprising water and oil, which allow the oil to be recovered in a form usable in the hydrocarbon industry and obtain water that is as decontaminated as possible, and which are efficient, inexpensive, eco-sustainable and with minimal environmental impact.

An objective of the present invention is to provide a method for the separation of aqueous mixtures or emulsions containing oil, or its derivatives, which is substantially devoid of the disadvantages of the methods illustrated above.

A further objective of the present invention is to provide a method for the separation of an oily substance or mixture such as natural lipophilic components of a vegetable (e.g. biodiesel), animal, or synthetic origin, or of components based on waxes and/or proteins, mixtures (hereinafter, also comprising oil and its fractions, referred to as “oily mixture”) from a mixture or emulsion thereof with water or from an aqueous solution optionally also comprising one or more salts or other dissolved substances (indicated hereunder as “aqueous medium”).

The present invention relates to a method for the partial or total separation of an oily mixture, preferably of oil, or its fractions, and water, or of an aqueous solution, starting from an emulsion or suspension of said oily mixture in an aqueous medium, wherein said method comprises the following steps:

a) adding to said emulsion or suspension of said mixture, optionally kept under stirring, an aqueous composition (C) comprising:
i. at least one of the following: citric acid, oxalic acid, tartaric acid, malic acid, acetic acid, the respective sodium or potassium salts, ethylenediaminetetraacetic acid (EDTA) preferably in the form of disodium salt, other complexing agents, natural or synthetic, and mixtures thereof, in a quantity ranging from 12 to 45% by weight with respect to the total weight of the composition (C);
ii. at least one solvent selected from methanol, ethanol, propanol and its isomers, preferably propylene glycol, butanol and its isomers, a low-molecular-weight ester soluble in water, preferably methyl acetate, ethyl acetate, ethyl formate, dimethyl carbonate, esters of carbonic acid and mixtures thereof, in a quantity ranging from 0.5 to 10% by weight with respect to the total weight of the composition (C);
iii. at least one surfactant selected from soy lecithin, soy lysolecithin, coco-glucoside, alkyl polyglucoside, glyceryl oleate, a linear sodium alkylbenzenesulfonate, sodium lauryl sulfate, sodium lauryl ether sulfate and mixtures thereof, in a quantity ranging from 1 to 7% in weight with respect to the total weight of the composition (C) and
iv. an apolar solvent selected from limonene or another analogous terpene, preferably citral or another terpene of a natural origin, tetrachlorethylene, carbon tetrachloride, other halogenated solvents, and mixtures thereof, in a quantity ranging from 0.3 to 10% by weight with respect to the total weight of the composition (C), obtaining an emulsion or suspension;
b) adding a non-metallic oxidizing agent to the emulsion or suspension obtained in step a), or to the initial emulsion or suspension simultaneously with the addition of the composition (C), obtaining a mixture or suspension;
c) adding a flocculant based on organic polymers to the mixture or suspension obtained in step b).

The present invention also relates to a kit for the partial or total separation of an oily mixture, preferably of oil, or its fractions, and of water, or of an aqueous solution, comprising at least:
a composition (C) in liquid form comprising at least water and:
   i. at least one of the following: citric acid, oxalic acid, tartaric acid, malic acid, acetic acid, and respective sodium or potassium salts, ethylenediaminetetraacetic acid (EDTA) preferably in the form of disodium salt, other natural or synthetic complexing agents, and mixtures thereof, in a quantity ranging from 12 to 45%, preferably from 20 to 45% by weight with respect to the total weight of the composition (C);
   ii. at least one solvent selected from methanol, ethanol, propanol and its isomers, preferably propylene glycol, butanol and its isomers, a low-molecular-weight ester soluble in water, preferably methyl acetate, ethyl formate, dimethyl carbonate, esters of carbonic acid, and mixtures thereof, in a quantity ranging from 0.5 to 10%, preferably from 2 to 5%, by weight with respect to the total weight of the composition (C);
   iii. at least one surfactant selected from soy lecithin, soy lysolecithin, coco-glucoside, alkyl polyglucoside, glyceryl oleate, a linear sodium alkylbenzenesulfonate, sodium lauryl sulfate, sodium lauryl ether sulfate, and mixtures thereof in a quantity ranging from 1 to 7%, preferably from 2 to 6%, by weight with respect to the total weight of the composition (C); and
   iv. an apolar solvent selected from limonene or another analogous terpene, preferably citral or another terpene of a natural origin, tetrachlorethylene, carbon tetrachloride, other halogenated solvents, and mixtures thereof, in a quantity ranging from 0.3 to 10%, preferably from 2 to 5%, by weight with respect to the total weight of the composition (C);
a non-metallic oxidizing agent, optionally in an aqueous solution or suspension; and
a flocculant based on organic polymers, optionally in an aqueous solution or suspension.

The following figures illustrate the advantages of the invention.

FIG. 1a-c: Steps of the separation of a mixture comprising a light paraffin-like crude oil;

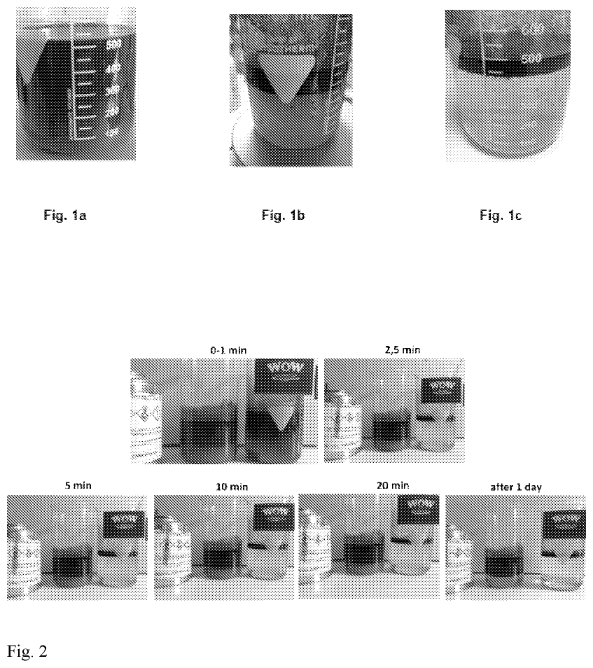

FIG. 2: Time sequence of the separation of a mixture comprising a light paraffin-like crude oil;

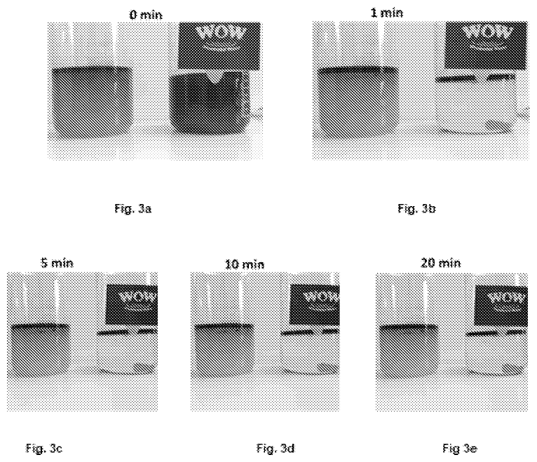

FIG. 3a-e: Steps for separating a mixture comprising a light crude oil;

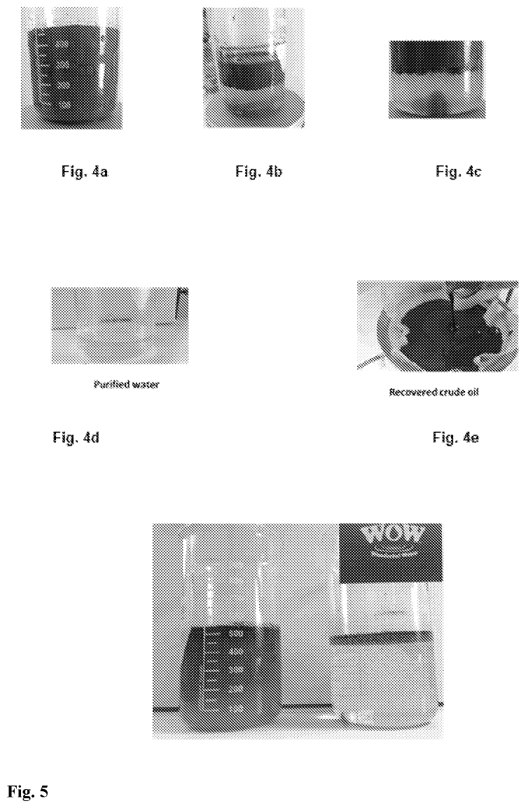

FIG. 4 a-d: Steps for separating a mixture comprising a heavy crude oil.

FIG. 5: Result of the treatment of a 4% OIW mixture with oil called ANCO (initial mixture on the left) with the kit of the invention (0.4 g/L, final result on the right);

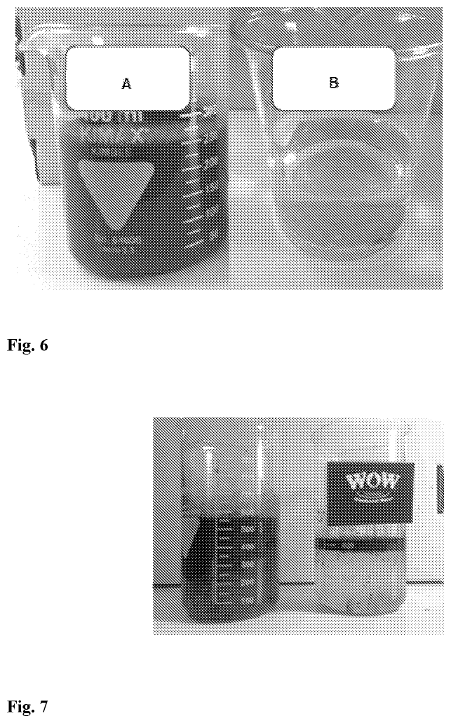

FIG. 6: Result of the treatment of a 10% OIW mixture with oil called ANCO (mixture A, left) with the kit of the invention (1.0 g/L, mixture B, right);

FIG. 7: Result of the treatment of a 20% OIW mixture with oil called ANCO (initial mixture on the left) with the kit of the invention (2.0 g/L, result after treatment, on the right).

Unless otherwise specified, within the context of the present invention, the indication that a composition “comprises” one or more components or substances means that other components or substances may also be present in addition to that, or those, specifically indicated.

Unless otherwise specified, within the scope of the present invention, a range of values indicated for a quantity, for example the weight content of a component, includes the lower and upper limits of the range. For example, if the weight or volume content of component A is indicated as “X to Y”, wherein X and Y are numerical values, A can be X or Y or any of the intermediate values.

Unless otherwise specified, within the scope of the present invention, the percentage quantities of the components refer to the ratio between the weight of said component with respect to the total weight of the composition (also indicated as % wt).

Within the scope of the present invention, citric acid can be indifferently in anhydrous or hydrated form, for example citric acid monohydrate. The quantities refer to anhydrous citric acid, unless otherwise specified, and, in the case of using hydrated citric acid, the quantities will consequently be proportionally adapted, in order to compensate for the differences in molecular mass.

The inventor has surprisingly found that large quantities of oil and derivatives can be efficiently and rapidly separated from aqueous media comprising aqueous mixtures and suspensions, also containing salt water, such as sea water, through the method as defined above, obtaining oil, which can be used in the hydrocarbon, oil and/or petrochemical industries, without the need for special treatment, and water practically devoid of oil contaminants that can be disposed of or used in various ways, optionally after routine treatment.

The method of the present invention is suitable for application for separating other oily substances such as natural lipophilic components of either a vegetable (e.g. biodiesel) or animal origin, or synthetic, or of components based on waxes and/or proteins.

The method of the present invention is particularly suitable for the total or partial removal of hydrocarbon mixtures consisting of, or comprising, oil, its derivatives or fractions or residues deriving from its processing. The method of the present invention, however, can also be applied, with excellent results in terms of efficiency and rapidity, to the removal of hydrocarbon mixtures consisting of, or comprising, hydrocarbons in general, waxes, tar, bitumen, paraffins, waste oils, greases (including fatty acids or their derivatives such as amides, esters, tri-, di- and mono-glycerides), oils, hydrocarbon compounds, pitches and similar substances.

The composition (C) as defined above advantageously allows said removal to be obtained with high efficiency and minimum environmental impact, as it contains highly biodegradable components, considered as being low-polluting, and also because it acts as an agglomerant transforming the compound being treated into an even more water-repellent compound, and increases its viscosity, making it easier to collect through mechanical means. This latter property is particularly advantageous for allowing the collection of oil, and its derivatives, treated by the composition (C) also in cases of emulsion which can be finally separated by means of a simple mechanical filter, for example a sieve-type filter.

In a preferred embodiment, in the method according to the present invention, the aqueous composition (C) comprises a quantity of at least one of the following: citric acid, oxalic acid, tartaric acid, malic acid, acetic acid, as well as the respective sodium or potassium salts (citrates, oxalates, tartrates, malates), ethylenediaminetetraacetic acid (EDTA) preferably in the form of disodium salt, other natural or synthetic complexing agents, or mixtures thereof, in a quantity ranging from 12 to 45%, more preferably from 20 to 35%, even more preferably from 25 to 30% by weight with respect to the total weight of the composition (C).

Within the scope of the present invention, isomer of propanol and butanol refers to at least one alcohol selected from n-propanol (1-propanol), iso-propanol (or 2-propanol), n-butanol (or 1-butanol), sec-butanol (or 2-butanol), iso-butanol (2-methyl-1-propanol), tert-butanol (2-methyl-2-propanol), propylene glycol and relative mixtures.

In a preferred embodiment, in the method of the present invention, the solvent ii. is ethanol, or a mixture of C₁-C₄ alcohols as defined above comprising at least ethanol. In a preferred embodiment, ethanol is preferred as alcohol or aliphatic alcohol.

Low-molecular-weight water-soluble ester refers to an ester with a molecular weight not exceeding 200 and with a water solubility which is such that one part of the solvent forms a clear, monophasic solution with 30 parts or less of water.

In a preferred embodiment, the preferred ester is ethyl acetate, methyl acetate, ethyl formate, dimethyl carbonate, carbonic acid esters and their mixtures, more preferably ethyl acetate and/or dimethyl carbonate.

In a preferred embodiment, in the method of the present invention, the solvent ii. is dimethyl carbonate, or a mixture comprising at least dimethyl carbonate.

In a preferred embodiment, in the method according to the present invention, the aqueous composition (C) comprises a quantity of aliphatic alcohol or ester ii. ranging from 0.5 to 10%, preferably from 2 to 8%, more preferably from 3 to 5% by weight with respect to the total weight of the composition (C).

Within the scope of the present invention, coco-glucoside refers to a non-ionic surfactant generally regarded as safe (GRAS). From the point of view of its chemical structure, it is an ether of C₈-C₁₆ fatty alcohols and glucose oligomers (CAS number 141464-42-8). In water, it forms a viscous, turbid solution and can be used for obtaining the composition (C) according to the invention also as an aqueous solution in which the percentage of active substance generally ranges from 50 to 60% by weight. It has excellent foaming properties and is advantageously biodegradable in relatively rapid times and without leaving residues, according to the criteria of the EC standard Nr. 648/2004 on detergents.

Within the scope of the present invention, “soy lecithin” refers to a phosphatidylcholine, i.e. a phosphoglyceride in which the phosphatidic acid is esterified with choline, which can be obtained, without limitation, from soybeans or their oil.

Within the scope of the present invention, “alkyl polyglucoside” refers to an ether including oligomers of glucose and/or other sugars such as maltose and at least one alkyl alcohol having from 8 to 16 carbon atoms, linear or branched, typically a mixture of alcohol, for example with a linear or branched alcohol (C8) or with an alcohol (C11) or with a mixture of caprylic (C8) and caprylic (C10) alcohols.

Within the scope of the present invention, “lysolecithin”, also called hydrolyzed lecithin or isocytin, (CAS Number 85711-58-6), refers to a derivative of lecithin wherein at least one fatty acid radical has been removed enzymatically at least in a part or in all of the phospholipids.

Within the scope of the present invention, the definition “terpene analogue of limonene” comprises, without limitation, compounds of a natural origin, terpenoids or having a monoterpenic, biterpenic, sequiterpenic structure, which are derivatives, precursors, diastereoisomers, optical isomers of limonene, or they include the structure of limonene in the chemical formula. Non-limiting examples of said terpenes are cyclic terpene compounds such as terpinene, terpineol, camphor, borneol, menthol, carvone, eucalyptol, bisabolen, bergamotene, carene, carano, pinene, thujene, sabinene, germacrene, valencene, caryophyllene, lemon oil and their derivatives, linear terpinene compounds such as: geraniol, citral, myrcene, nerol, neral, citronellol, citronellal, linalool, linalyl acetate, ocimene, farnesol and their derivatives, aromatic terpene compounds such as: eugenol, anethole, thymol, safrole, chavicol and their derivatives and their isomers, and mixtures thereof. The composition (C) according to the present invention can contain terpenes, or analogues, in the form of mixtures such as natural extracts of citrus fruits or other plants or matrices of a natural origin.

In a preferred embodiment, in the method of the present invention the terpene analogue of limonene is at least one of citral, geraniol, menthol, eucalyptol, lemon oil and citronellol.

Within the scope of the present invention, the definition “natural or synthetic complexing agents” refers to compounds capable of forming, reversibly or irreversibly, complexes with heavy metals and/or other contaminants. Non-limiting examples of said complexing agents are, in addition to EDTA and its salts, DTPA (diethylenetriaminopentaacetic acid), nitrilotriacetic acid, phosphonates, glycine, polysaccharides, polypeptides, glutamic acid, histidine, polynucleic acids, macrolides, crown ethers, ionophores and mixtures thereof.

In a preferred embodiment of the present invention, the surfactant iii. in the composition (C) it is at least one of lecithin, lysolecithin, alkyl polyglucoside (C8) or (C11), having a linear or branched chain, and mixtures thereof.

In a preferred embodiment, in the method according to the present invention, the aqueous composition (C) comprises a quantity of surfactant iii. ranging from 2 to 7%, preferably from 3 to 6%, more preferably from 4 to 5% by weight with respect to the total weight of the composition (C).

In a preferred embodiment, in the method of the present invention, the apolar solvent iv. is limonene, citral or another analogous terpene (preferably of a natural origin), tetrachlorethylene, carbon tetrachloride, other halogenated solvents, and mixtures thereof, in a quantity ranging from 0.3% to 10%, preferably from 0.5% or 2% to 5%, by weight with respect to the total weight of the composition. In a preferred embodiment, limonene, citral or a mixture thereof is the preferred apolar solvent.

In a preferred embodiment, in the method according to the present invention, the aqueous composition (C) comprises a quantity of apolar solvent iv. in a quantity ranging from 0.5 to 7.5%, preferably from 2 to 5%, by weight with respect to the total weight of the composition.

In a preferred embodiment, the composition of the present invention comprises limonene, citral or another analogous terpene, preferably of a natural origin, or a mixture thereof, in a mixture with lecithin or lysolecithin, more preferably obtained from soybeans, or with at least one alkyl polyglucoside.

In a preferred but non-limited embodiment, the three components i., ii. and iii. are in a weight ratio between each other ranging from 6:1:1 to 20:5:6.

In a preferred embodiment of the present invention, in the composition (C), the acid i. is citric acid, the aliphatic alcohol ii. is ethanol or dimethylcarbonate, the surfactant iii. is lecithin and the apolar solvent iv. is limonene, citral or a mixture thereof.

In a preferred embodiment, in the method according to the present invention, the non-metallic oxidizing agent is at least one of the following: hydrogen peroxide, sodium hypochlorite, sodium percarbonate, peracetic acid, perchloric acid, peroxydisulfuric acid, their salts, such as sodium persulfate, and relative mixtures.

In a preferred embodiment, in the method according to the present invention, the flocculant based on organic polymers is at least one synthetic water-soluble polyelectrolyte selected from an anionic polyelectrolyte (or polyacid), preferably a polyacrylic, polymethacrylic, polyethylene sulfonic, polystyrenesulfonic acid or mixtures thereof, a cationic (or polybasic) polyelectrolyte, preferably at least one of a polyacrylamide, a polyvinylamine, a polyvinylpyridine and mixtures thereof.

In a preferred embodiment, particularly advantageous if the emulsion or suspension comprises light oil, in the method according to the present invention, at least one thickener is also added to the mixture selected from a sedimentary siliceous rock of an organic origin, such as a diatomaceous earth or diatomaceous earth, and a phyllosilicate, such as bentonite, or mixtures thereof. Said thickener is preferably added in step a) of the method according to the invention.

In a preferred embodiment of the present invention, in step a), the composition (C) is added in a quantity ranging from 0.2 to 3 g for every 100 g of oily mixture in the aqueous medium, and/or in step b), or alternatively, simultaneously with the addition of the composition (C), the non-metallic oxidizing agent is added in a quantity of 0.2 to 3 g for every 100 g of oily mixture in the aqueous medium, and/or in step c) the flocculant based on organic polymers is added in a quantity ranging from 5 to 500 mg for every 100 g of oily mixture in the aqueous medium. In addition, if necessary, a thickener can be added, selected from a sedimentary siliceous rock of an organic origin, such as a diatomaceous earth or diatomite, and a phyllosilicate, such as bentonite, or mixtures thereof, in a quantity ranging from 50 mg to 1,000 mg for every 100 g of oil in water. The quantity of additives specified above is proportional to the quantity of oil treated.

The composition (C) in the method according to the present invention can be in liquid or semi-liquid form, for example, without limitation, in the form of an aqueous solution, suspension, gel, concentrate to be diluted and the like.

It has been surprisingly found that the method according to the invention allows water to be efficiently and rapidly separated from oil, and similar substances. The rapidity of the treatment is particularly advantageous for limiting the time of the operations.

The method according to the present invention can comprise the separation of the aqueous mixture comprising the components of (C) and the residues of the oil and other components through any of the methods known to skilled persons in the field (such as skimmers, oil scrapers and the like).

An embodiment of the present invention relates to a kit for the partial or total separation of an oily mixture, preferably of oil, or its fractions, and water, or an aqueous solution, comprising at least:

a detergent composition (C) in liquid form comprising at least water and:

i. at least one of the following: citric acid, oxalic acid, tartaric acid, malic acid, and respective sodium or potassium salts, ethylenediaminetetraacetic acid (EDTA) preferably in the form of disodium salt, other complexing agents, natural or synthetic, and mixtures thereof, in a quantity ranging from 12 to 45%, preferably from 20 to 45% by weight with respect to the total weight of the composition (C);
ii. at least one solvent selected from methanol, ethanol, propanol and its isomers, preferably propylene glycol, butanol and its isomers, a low-molecular-weight ester soluble in water, preferably methyl acetate, ethyl acetate, ethyl formate, dimethyl carbonate, esters of carbonic acid and mixtures thereof, in a quantity ranging from 0.5 to 10%, preferably from 2 to 5%, by weight with respect to the total weight of the composition (C);
iii. at least one surfactant selected from soy lecithin, soy lysolecithin, coco-glucoside, alkyl polyglucoside, glyceryl oleate, a linear sodium alkylbenzenesulfonate, sodium lauryl sulfate, sodium laurylether sulfate, and mixtures thereof in a quantity ranging from 1 to 7%, preferably from 2 to 6%, by weight with respect to the total weight of the composition (C); and
iv. an apolar solvent, selected from limonene or another analogous terpene, preferably citral or another analogous terpene of a natural origin, tetrachlorethylene, carbon tetrachloride, other halogenated solvents, and mixtures thereof, in a quantity ranging from 0.3 to 10%, preferably 25%, by weight with respect to the total weight of the composition (C);

a non-metallic oxidizing agent, optionally in an aqueous solution or suspension; and

a flocculant based on organic polymers, optionally in an aqueous solution or suspension.

In a preferred embodiment of the present invention, in the kit, the acid i. is citric acid and/or the solvent ii. is ethanol, ethyl acetate, dimethyl carbonate or mixtures thereof and/or the surfactant iii. is lecithin or alkyl polyglucoside, particularly (C8) or (C11), having a linear or branched chain, or mixtures thereof and/or the apolar solvent iv. is limonene, citral or mixtures thereof, wherein the acid i. is preferably citric acid, the solvent ii. is ethanol or ethyl acetate, the surfactant iii. is lecithin and the apolar solvent iv. is limonene or wherein the acid i. is citric acid, the solvent ii. is ethanol or ethyl acetate, the surfactant iii. is alkyl polyglucoside, the apolar solvent iv. is limonene and/or the non-metallic oxidizing agent is at least one of the following: hydrogen peroxide, sodium hypochlorite, sodium percarbonate, peracetic acid, perchloric acid, peroxydisulfuric acid, their salts, and mixtures thereof, and/or the flocculant based on organic polymers is at least one synthetic water-soluble polyelectrolyte selected from an anionic polyelectrolyte (or polyacid), preferably a polyacrylic, polymethacrylic, polyethylene sulfonic, polystyrene sulfonic acid or mixtures thereof, a cationic (or polybasic) polyelectrolyte, preferably at least one of the following: a polyacrylamide, a polyvinylamine, a polyvinylpyridine and mixtures thereof.

In a preferred embodiment, particularly advantageous if the emulsion or suspension comprises light oil, the kit according to the present invention also comprises at least one thickener selected from a sedimentary siliceous rock of an organic origin, such as a diatomaceous earth or diatomite, and a phyllo silicate, such as bentonite, or mixtures thereof. Said thickener is preferably part of said detergent composition. The composition (C) in the kit according to the present invention can comprise further components in addition to the acid i., the solvent ii., the surfactant iii. and the apolar solvent iv.

As non-limiting examples, said components can include salts, other surfactants, emulsifiers, preservatives, thickeners, natural extracts and their mixtures.

In a preferred embodiment, the composition according to the present invention further comprises at least one of the following: sodium chloride, sodium acetate, trisodium citrate, sodium perborate, sodium percarbonate, acetic acid (also in the form of vinegar), orthophosphoric acid, a thickener such as a zeolite or xanthan gum, a carbonate and/or bicarbonate of an alkaline metal (such as sodium carbonate and sodium bicarbonate), limonene or another analogous terpene (preferably of a natural origin).

Limonene in the composition (C) of the present invention can, without limitation, be racemic limonene (CAS number 138-86-3) or D-limonene (CAS Number 5989-54-8) or any scalemic mixture of the two enantiomers. The composition preferably comprises a mixture of limonene, or another analogous terpene, and soy lecithin or soy lysolecithin.

In the composition (C) according to the present invention, limonene or another analogous terpene, when present, is preferably contained in a quantity ranging from 0.3 to 7.5%, more preferably from 1 to 3%, by weight with respect to the total volume of the composition (C), and/or lecithin or lysolecithin is contained in a quantity ranging from 0.1 to 1% by weight with respect to the total volume of the composition (C).

In a preferred embodiment, the apolar solvent iv. is limonene, citral or a mixture thereof and the solvent i. is ethyl acetate or dimethyl carbonate.

The composition (C) according to the present invention is characterized by a good foaming effect, a moderate wetting power, an excellent detergent and emulsifying power and a good solubilizing power. Furthermore, the composition (C) according to the present invention can be used by operators wearing light clothing and protective devices, it generally does not cause gas releases, is of almost completely biological origin and any possible dispersion into the environment could only cause minimal environmental consequences.

The method and the kit according to the present invention allow the separation of oil, or analogues, from water with minimal contamination of the water and the environment and do not alter the quality and performance of the oil that is recovered.

In general, the process according to the invention is effective for separating mixtures or suspensions containing water and oil in ratios ranging from 0.01% by weight to 75% by weight and from 75% by weight to 0.01% by weight and for compositions comprising oil from different sources (e.g. light crude oil, paraffin, heavy crude oil, blends).

The following examples are provided for illustrating some embodiments of the invention, without limiting its scope.

The tests were carried out using compositions containing from 1% to 20% of oil in water (by volume) but, as indicated above; with the method according to the present invention it is also possible to obtain the separation of mixtures comprising larger quantities of oil or water.

### EXAMPLE 1

A separation test was carried out using a volume of 520 ml of a suspension comprising water, a light paraffin-like crude oil in a concentration of 100 g/L and NaCl (33 g/L) in a 600 ml beaker (FIG. 1a).

A quantity equal to 1 g/L of a mixture containing water (850 ml), citric acid monohydrate (80 g), branched C₈ alkyl polyglucoside (60 g), C₁₁ alkyl polyglucoside (8 g), acetic acid (6 g), limonene (1 g) and ethyl acetate (50 g) was added to the suspension, and a quantity equal to 1 g/l of hydrogen peroxide in aqueous suspension.

After 15 minutes under stirring, the disintegration of the emulsion was observed followed by the formation of a dark upper layer and a semi-transparent lower layer (FIG. 1b).

An emulsion of a cationic polyacrylamide in water (15 mg per liter of suspension) was then added. The system was stirred for 15 minutes and left to rest for at least 1 minute. A biphasic system was obtained (FIG. 1c) with the complete separation of oil (upper dark phase) from water (lower clear phase).

The separation sequence is shown in FIG. 2 (the beaker on the left contains the untreated mixture, that on the right contains the mixture during and after treatment). It was observed that the biphasic system is stable even 24 hours after treatment.

### EXAMPLE 2

The procedure of Example 1 was repeated in the same way and obtaining the same results also with an emulsion of water and light crude oil. As a possible variant, before adding the emulsion of a cationic polyacrylamide in water (15 mg per liter of suspension), diatomaceous earth (150 mg/1) can be added.

### EXAMPLE 3

The procedure of Examples 1 and 2 was repeated starting from a mixture of water and heavy crude oil. After the addition of the polyacrylamide, the apparent solidification of the oil was observed (FIG. 4c), which can be separated by filtration on paper or by mechanical separation, obtaining a hydrocarbon phase (FIG. 4d) and a colourless and odourless aqueous phase (FIG. 4e).

### EXAMPLE 4

A further test was carried out on an oil sample called ANCO (from Azerbaijan) which represents the mixture of various common oils. It was found that mixtures of oil in water (OIW) at 5%, 10% and 20% by weight/weight can be efficiently separated using increasing quantities of the three components of the kit according to the invention. It is therefore possible to obtain the separation of complex mixtures by simply modulating the quantities of the components of the kit of the invention.

| OIW | Mixture (C) | Oxidant | Flocculant | |
|---|---|---|---|---|
| [%]) | [g/L] | [g/L] | [mg/L] | Results |
| 4 | 0.4 g/L | 0.4 g/L | 6 | High efficiency, See FIG. 5 |
| 10 | 1.0 g/L | 1.0 g/L | 15 | High efficiency, See FIG. 6 |
| 20 | 2.0 g/L | 2.0 g/L | 30 | Efficient, See FIG. 7 |

1. A method for the partial or total separation of an oily mixture preferably of oil, or fractions thereof, and water, or an aqueous solution, starting from an emulsion or suspension of the oily mixture in an aqueous medium, wherein said method comprises the following steps:
a) adding to said emulsion or suspension of said mixture, optionally kept under stirring, an aqueous composition (C) comprising:
i. at least one of the following: citric acid, oxalic acid, tartaric acid, malic acid, acetic acid, the respective sodium or potassium salts, ethylenediaminetetraacetic acid (EDTA) preferably in the form of disodium salt, other natural or synthetic complexing agents, and mixtures thereof, in a quantity ranging from 12 to 45% by weight, with respect to the total weight of the composition (C);
ii. at least one solvent selected from methanol, ethanol, propanol and its isomers, preferably propylene glycol, butanol and its isomers, a low-molecular-weight water-soluble ester, preferably methyl acetate, ethyl acetate, ethyl formate, dimethyl carbonate, carbonic acid esters and mixtures thereof, in a quantity ranging from 0.5 to 10% by weight, with respect to the total weight of the composition (C);
iii. at least one surfactant selected from soy lecithin, soy lysolecithin, coco-glucoside, alkyl polyglucoside, glyceryl oleate, a linear sodium alkylbenzenesulfonate, sodium lauryl sulfate, sodium lauryl ether sulfate and mixtures thereof, in a quantity ranging from 1 to 7% by weight with respect to the total weight of the composition (C) and
iv. an apolar solvent, selected from limonene or another analogous terpene, preferably citral or another terpene of a natural origin, tetrachloroethylene, carbon tetrachloride, other halogenated solvents, and mixtures thereof, in a quantity ranging from 0.3 to 10% by weight with respect to the total weight of the composition (C), obtaining an emulsion or suspension;
b) adding to the emulsion or suspension obtained in step a), or to the initial emulsion or suspension simultaneously with the addition of the composition (C), a non-metallic oxidizing agent, obtaining a mixture or suspension;
c) adding to the mixture or suspension obtained in step b), a flocculant based on organic polymers.

2. The method according to claim 1, wherein the aqueous composition (C) comprises a quantity of at least one of the following: citric acid, oxalic acid, tartaric acid, malic acid, acetic acid and the respective sodium or potassium salts, ethylenediaminetetraacetic acid (EDTA), other natural or synthetic complexing agents, and mixtures thereof, ranging from 20 to 35%, by weight with respect to the total weight of the composition (C).

3. The method according to claim 1, wherein the aqueous composition (C) comprises a quantity of solvent ii. ranging from 2 to 5% by weight with respect to the total weight of the composition (C).

4. The method according to claim 1, wherein the aqueous composition (C) comprises a quantity of surfactant iii. ranging from 2 to 6%, by weight with respect to the total weight of the composition (C), or wherein the aqueous composition (C) comprises a quantity of apolar solvent iv. in a quantity ranging from 2 to 5%, by weight with respect to the total weight of the composition (C).

5. The method according to claim 1, wherein the acid i. is citric acid and/or the solvent ii. is ethanol, ethyl acetate, dimethyl carbonate or mixtures thereof and/or the surfactant iii. is lecithin or alkyl polyglucoside having a linear or branched chain, or mixtures thereof, or the apolar solvent iv. is limonene, citral or mixtures thereof.

6. The method according to claim 1, wherein the non-metallic oxidizing agent is at least one of the following: hydrogen peroxide, sodium hypochlorite, sodium percarbonate, peracetic acid, perchloric acid, peroxydisulfuric acid, their salts, and mixtures thereof.

7. The method according to claim 1, wherein the flocculant based on organic polymers is at least one of the following: a synthetic water-soluble polyelectrolyte selected from an anionic (or polyacid) polyelectrolyte.

8. The method according to claim 1, wherein in step a), the composition (C) is added in a quantity ranging from 0.2 to 3 g for every 100 g of oily mixture in the aqueous medium, or in step b), or alternatively, together with the addition of the composition (C), the non-metallic oxidizing agent is added in a quantity ranging from 0.2 to 3 g for every 100 g of oily mixture in the aqueous medium, or in step c) the flocculant based on organic polymers is added in a quantity ranging from 5 to 500 mg for every 100 g in the oily mixture.

9. A kit for the partial or total separation of an oily mixture preferably of oil, or its fractions, and water, or an aqueous solution, comprising at least:
a composition (C) in liquid form comprising at least water and:
i. at least one of the following: citric acid, oxalic acid, tartaric acid, malic acid, acetic acid, and the respective sodium or potassium salts, ethylenediaminetetraacetic acid (EDTA), preferably in the form of disodium salt, other natural or synthetic complexing agents, and mixtures thereof, in a quantity ranging from 12 to 45%, preferably from 20 to 45% in weight with respect to the total weight of the composition;
ii. at least one solvent selected from methanol, ethanol, propanol and its isomers, preferably propylene glycol, butanol and its isomers, a low-molecular-weight water-soluble ester, preferably methyl acetate, ethyl acetate, ethyl formate, dimethyl carbonate, esters of carbonic acid and mixtures thereof, in a quantity ranging from 0.5 to 10%, preferably from 2 to 5% in weight with respect to the total weight of the composition;
iii. at least one surfactant selected from soy lecithin, soy lysolecithin, coco-glucoside, alkyl polyglucoside, glyceryl oleate, a linear sodium alkylbenzenesulfonate, sodium lauryl sulfate, sodium lauryl ether sulfate and mixtures thereof, in a quantity ranging from 1 to 7%, preferably from 2 to 6%, in weight with respect to the total weight of the composition; and
iv. an apolar solvent, selected from limonene or another analogous terpene, preferably citral or another terpene of a natural origin, tetrachloroethylene, carbon tetrachloride, other halogenated solvents, and mixtures thereof in a quantity ranging from 0.3 to 10%, preferably from 2 to 5%; by weight with respect to the total weight of the composition;
a non-metallic oxidizing agent; and
a flocculant based on organic polymers.

10. The kit according to claim 9, wherein the acid i. is citric acid or the solvent ii. is ethanol, ethyl acetate, dimethyl carbonate or mixtures thereof, or the surfactant iii. is lecithin or alkyl polyglucoside, having a linear or branched chain, or mixtures thereof, or the apolar solvent iv. is limonene, citral or mixtures thereof, or the non-metallic oxidizing agent is at least one of the following: hydrogen peroxide, sodium hypochlorite, sodium percarbonate, peracetic acid, perchloric acid, peroxydisulfuric acid, their salts, and mixtures thereof, or the flocculant based on organic polymers is at least one of the following: a synthetic water-soluble polyelectrolyte selected from an anionic (or polyacid) polyelectrolytea cationic (or polybasic) polyelectrolyte, or the kit comprises at least one thickening agent selected from a sedimentary siliceous rock of an organic origin and a phyllosilicateor mixtures thereof.
